(19) United States
(12) Patent Application Publication
(10) Pub. No.: US 2022/0035298 A1
(43) Pub. Date: Feb. 3, 2022

(54) IMAGE DATA SETTING APPARATUS, IMAGE DATA SETTING METHOD AND NON-TRANSITORY COMPUTER-READABLE RECORDING MEDIUM

(71) Applicant: KONICA MINOLTA, INC., Tokyo (JP)

(72) Inventor: Tatsuro YAMAMURO, Chiba (JP)

(73) Assignee: KONICA MINOLTA, INC., Tokyo (JP)

(21) Appl. No.: 17/366,671

(22) Filed: Jul. 2, 2021

(30) Foreign Application Priority Data
Jul. 29, 2020 (JP) 2020-128385

(51) Int. Cl. G03G 15/00; G06K 15/02; G03G 15/20; G03G 15/22

(52) U.S. Cl. CPC G03G 15/6582; G06K 15/1881; G03G 2215/00793; G03G 15/225; G03G 15/2014

(57) ABSTRACT

Provided is an image data setting apparatus capable of setting image data related to a foil forming image. The image data setting apparatus includes a hardware processor determining whether a setting for the foil forming image is included in a printing job related to the image data, in which the hardware processor changes a halftone dot setting of the image data, according to a determination result.

### CROSS REFERENCE TO RELATED APPLICATIONS

The entire disclosure of Japanese Patent Application No. 2020-128385 filed on Jul. 29, 2020 is incorporated herein by reference in its entirety.

### BACKGROUND

### Technological Field

The present invention relates to an image data setting apparatus, an image data setting method and a non-transitory computer-readable recording medium.

### Description of Related Art

Conventionally, systems have been known, which are capable of forming foil forming images in which foils are formed on images, using hot stamping (foil stamping) apparatuses (see, for example, Japanese Patent Application Laid-Open No. 2018-189719). In such a system, for example, after an image (toner image) is formed on a recording medium, foil is pressed onto the image to use the toner as an adhesive for the foil, and thereby a foil forming image is formed on tile recording medium.

### SUMMARY

Meanwhile, in commercial printing, objects having tones such as gradations may be formed. In such a case, forming gradations using halftone dots (small dots), such as 175 lines is common in the commercial printing.

However, in a case of forming the above-mentioned object in the foil forming image, using the same setting as when forming a normal image may cause a situation where the tones of the object cannot be accurately expressed because the halftone dots are so small for the foils that adjacent foils are connected to each other.

An object of the present invention is to provide an image data setting apparatus, an image data setting method and a non-transitory computer-readable recording medium, which are capable of accurately performing hot stamping processing even on an object having tones such as gradations. and thereby accurately expressing the tones by the foils.

To achieve at least one of the abovementioned objects, according to an aspect of the present invention, an image data setting apparatus reflecting one aspect of the present invention is capable of setting image data related to a foil forming image, the image data setting apparatus including:

a hardware processor determining whether a setting for the foil forming image is included in a printing job minted to the image data, wherein

the hardware processor changes a halftone dot setting of the image data, according to a determination result.

To achieve at least one of the abovementioned objects, according to an aspect of the present invention, an image data setting method reflecting one aspect of the present invention is for an image data setting apparatus capable of setting image data related to a foil forming image, the image data setting method including:

determining whether a setting for the foil forming image is included in a printing job related to the image data; and

changing a halftone dot setting of the image data, according to a determination result.

To achieve at least one of the abovementioned objects, according to an aspect of the present invention, a non-transitory computer-readable recording medium reflecting one aspect of the present invention stores therein an image data setting program for an image data setting apparatus capable of setting image data related to a foil forming image, the program causing a computer to perform:

determining whether a setting for the foil forming image is included in a printing job related to the image data; and

changing a halftone dot setting of the image data, according to a determination result in the determining.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 schematically illustrates a configuration of an image forming system according to an embodiment of the present invention;

FIG. 2A illustrates an example of a conventional arrangement of foils;

FIG. 2B illustrates an example of an arrangement of foils according to the present embodiment;

FIG. 3 is a flowchart illustrating an exemplary operation of image data setting control in an image data setting apparatus;

FIG. 4 is a flowchart illustrating an exemplary operation of image data setting control based on a foil type in the image data setting apparatus;

FIG. 5 is a flowchart illustrating an exemplary operation of image data setting control based on a recording medium setting in the image data setting apparatus;

FIG. 6 is a flowchart illustrating an exemplary operation of image data setting control based on a toner type in the image data setting apparatus;

FIG. 7 is a flowchart illustrating an exemplary operation of image data setting control based on an image density in the image data setting apparatus;

FIG. 8 is a flowchart illustrating an exemplary operation of image data setting control in the image data setting apparatus;

FIG. 9 is a flowchart illustrating an exemplary operation of image data setting control in the image data setting apparatus;

FIG. 10 is a flowchart illustrating an exemplary operation of image data setting control in the image data setting apparatus that adjusts a second angle; and

FIG. 11 is a flowchart illustrating an exemplary operation of image data, setting control in the image data setting apparatus.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, one or more embodiments of the present invention will be described in detail with reference to the accompanying drawings.

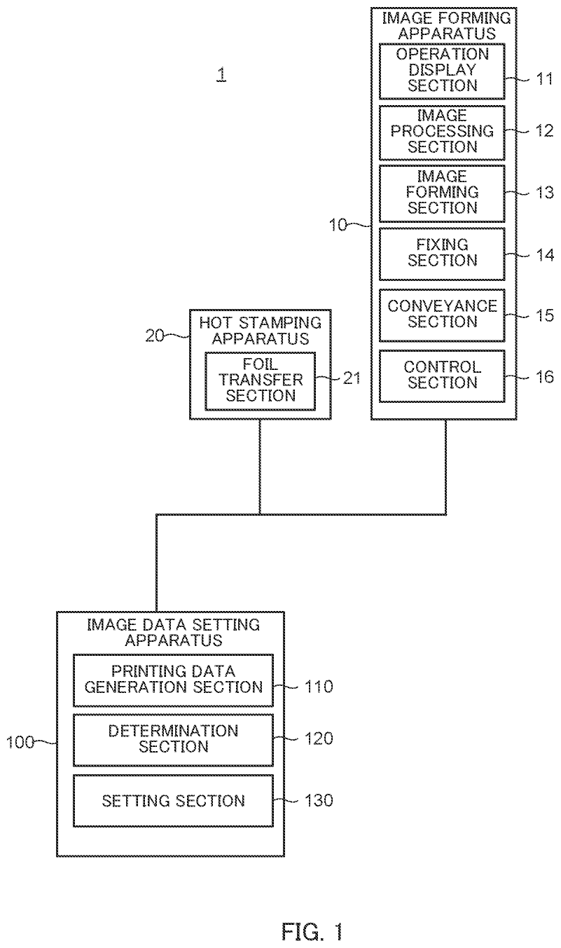

As illustrated in FIG. 1, image forming system 1 according to an embodiment of the present invention is a system capable of forming a foil forming image on a recording medium and includes image forming apparatus 10, hot stamping apparatus 20, and image data setting apparatus 100.

Image forming apparatus 10 is, for example, a color image forming apparatus of an intermediate transfer system using electrophotographic process technology. Specifically, image forming apparatus 10 primarily-transfers toner images of respective colors of yellow (Y), magenta (M), cyan (C), and black (K) formed on photoconductor drums onto an intermediate transfer belt, superimposes the toner images of the four colors on one another on the intermediate transfer belt, and then secondarily-transfers the toner images to sheet S fed from a sheet feeding tray unit to thereby forming an image.

Image forming apparatus 10 obtains image data based on a printing job via image data setting apparatus 100 and forms an output image based on the image data on a recording medium. Image forming apparatus 10 includes operation display 11, image processing section 12, image forming section 13, fixing section 14, conveyance section 15, control section 16, and the like.

Control section 16 includes a Central Processing Unit (CPU), a Read Only Memory (ROM), a Random Access Memory (RAM), and the like. The CPU reads a program corresponding to processing contents from the ROM and loads the program into the RAM, and controls operation of, for example, each block of image forming apparatus 10 in a centralized manner in cooperation with the loaded program.

Operation display section 11 is configured of, for example, a Liquid Crystal Display (LCD) with a touchscreen and functions as a display section and an operation section. The display section displays various operation screens, the statuses of images, the operation statuses of the respective functions, and the like in accordance with display control signals input from control section 16. The operation section includes various operation keys such as a numeric keypad and a start key and receives various input operations by the user to output the operation signal to control section 16.

Image processing section 12 includes, for example, circuitry which performs digital image processing according to an initial or user setting. For example, image processing section 12 performs tone correction based on tone correction data (tone correction table) under the control of control section 16.

Image forming section 13 forms an image (toner image) on a recording medium based on image data after image processing. Image forming section 13 includes, for example, an image forming unit and an intermediate transfer unit for forming an image with the respective color toners of a Y component, an M component, a C component, and a K component.

Fixing section 14 fixes the toner image to the recording medium by heating and pressurizing, using a fixing nip, the conveyed recording medium on which the toner image has been transferred.

Conveyance section 15 includes a sheet feeding section, a sheet ejection section, a conveyance path section, and the like. Sheet feeding section houses the recording medium identified based on basis weight, size, or the like.

The conveyance path section includes a plurality of pairs of conveyance rollers such as a resist roller pair, a normal conveyance path or the like which passes the recording medium through image forming section 13 and fixing section 14 to eject the recording medium out of image forming apparatus 10.

The recording mediums housed in the sheet feeding section are sent out one by one from the uppermost part and conveyed to image forming section 13 by the conveyance path section. In image forming section 13, the toner images on the intermediate transfer belt are secondarily-transferred collectively to one surface of the recording medium, and fixing processing is performed thereon in fixing section 14. The image-formed recording medium is ejected out of the apparatus by the sheet ejection section equipped with a sheet ejection roller.

Hot stamping apparatus 20, when the printing job includes a setting for the foil forming image, performs hot stamping processing to the recording medium so as to form the foil forming image on the recording medium. Hot stamping apparatus 20 includes, for example, foil transfer section 21 placed on or near a conveyance path of the recording medium ejected from image forming apparatus 10.

Foil transfer section 21 includes, for example, a heating roller and a pressure roller forming a transfer nip, and transfers the foil to the recording medium by melting the toner image on the recording medium passing through the transfer nip so as to use the toner image as an adhesive. Note that, the transfer nip of foil transfer section 21 is to be supplied with, for example, a foil sheet on which a foil is laminated.

Thus, in image forming system 1, the foil forming image can be formed onto the recording medium by using image forming apparatus 10 and hot stamping apparatus 20.

Image data setting apparatus 100 is, for example, a computer device such as a personal computer. Image data setting apparatus 100 includes the CPU, ROM, RAM, and the like, and is capable of setting image data related to the foil forming image in the printing job. Image data setting apparatus 100 includes printing data generation section 110, determination section 120, and setting section 130.

Printing data generation section 110 generates, for example, image data related to the printing job which is input in image forming system 1. The image data includes data of images formed by image forming apparatus 10 and foil data of the foil forming image formed by hot stamping apparatus 20.

Determination section 120 determines whether the printing job, which is related to the image data generated by printing data generation section 110, includes the setting for the foil forming image. The setting for the foil forming image means a setting having a part to which hot stamping processing is applied by hot stamping apparatus 20 in the image data.

In a case where the image data has the part to which hot stamping processing is applied by hot stamping apparatus 20, determination section 120 determines that the setting for the foil forming image is included in the printing job. In contrast, in a case where the image data has no part to which hot stamping processing is applied by hot stamping apparatus 20, determination section 120 determines that the setting for the foil forming image is not included in the printing job.

Setting section 130 changes a setting for the halftone dots (hereinafter, may be also referred to as “halftone dot setting”) in the image data according to the determination result of determination section 120. Specifically, in a case where determination section 120 determines that the setting for the foil forming image is not included in the printing job, setting section 130 sets the halftone dot setting to the first setting. The first setting is a general setting for forming a normal image without forming foil. In one example, a setting in which the number of lines of halftone dots (hereinafter, may be also referred to as “line number of halftone dots”) is set to 175 lines.

In a case where determination section 120 determines that the setting for the foil forming image is included in the printing job, setting section 130 sets the halftone dot setting to the second setting.

The second setting means a setting in which the line number of halftone dots is set to be less than that of the first setting. That is, in the second setting, the line number of halftone dots is set to the number such that, when foils are arranged in the respective halftone dots, adjacent foils are not connected to each other (e.g. 60 lines). In a case where determination section 120 determines that the setting for the foil forming image is included in the printing job, setting section 130 controls the halftone dot setting so that adjacent foils are not connected to each other when foils are arranged in the respective halftone dots.

Meanwhile, in image forming system 1, printing may be performed such that an object having tones such as gradations is formed on a recording medium. In commercial printing, when forming the gradations, a printed matter is commonly generated by using relatively small halftone dots such as the 175 lines.

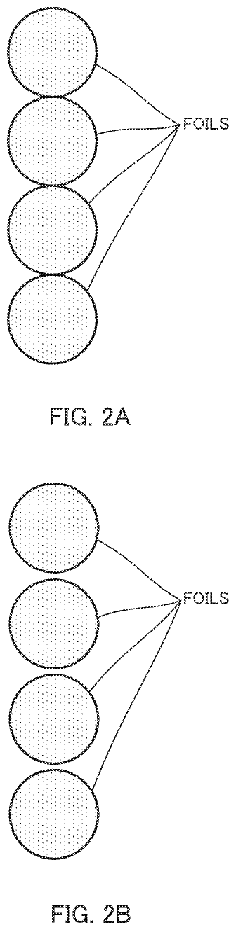

However, in a case of forming the above-mentioned object in the foil forming image, using the same setting as when forming a normal image may cause a situation where the tones of the object cannot be accurately expressed because the halftone dots are so small for the foils that adjacent foils are connected to each other (for example, see FIG. 2A).

In the present embodiment, the halftone dot setting is set to the second setting that has the smaller line number than the normal first setting in a case of forming the foil forming image; thus, it is possible to accurately represent the gradation is arranged without connecting the foil adjacent (e.g., see FIG. 2B). That is, in the present embodiment, the hot stamping processing is performed accurately even on the object having tones such as gradations, and thereby the tones by the foils can be expressed accurately.

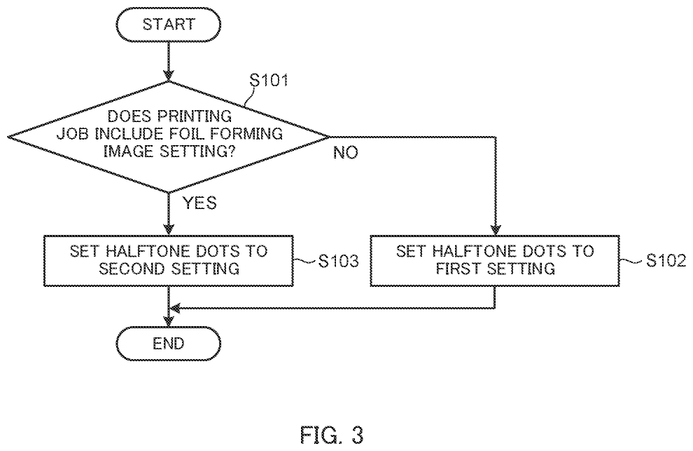

A description will be given of an exemplary operation of image data setting control in image data setting apparatus 100 configured as described above. FIG. 3 is a flowchart illustrating the exemplary operation of the image data setting control in image data setting apparatus 100. Processing in FIG. 3 is appropriately performed when, for example, image data setting apparatus 100 receives an execution command of the printing job.

As illustrated in FIG. 3, image data setting apparatus 100 determines whether the printing job includes the setting for the foil forming image setting (step S101). When the determination result indicates that the printing job includes no setting for the foil forming image (step S101, NO), image data setting apparatus 100 sets the halftone dots to the first setting (step S102).

In contrast, when the printing job includes the setting for the foil forming image (step S101, YES), image data setting apparatus 100 sets the dost to the second setting (step S103). After step S102 or step S103, the control ends.

According to the present embodiment configured as described above, the hot stamping processing is performed accurately even on the object having tones such as gradations, and thereby the tones by the foils can be expressed accurately.

Note that, in the above embodiment, the type of foils is not mentioned, but the present invention is not limited to this. For example, setting section 130 may control the line number of halftone dots in the halftone dot setting based on the foil type used for the foil forming image.

For example, a foil with a poor pressure-attachment rate compared to tile normal color foil, such as metallic foil, hologram foil, rainbow foil, may be used for the foil forming image. In such cases, using the same line number as the normal colored foil may cause a situation where the hot stamping processing cannot be performed accurately.

Hence, setting section 130 controls the line number of halftone dots in accordance with the pressure-attachment rate of the foil. Specifically, for example, setting section 130 controls the line umber of halftone dots so that the smaller the pressure-attachment rate of the foil is, the smaller the line number of halftone dots is.

Thus, it is possible to accurately set the halftone dot setting and thereby perform the accurate hot stamping processing.

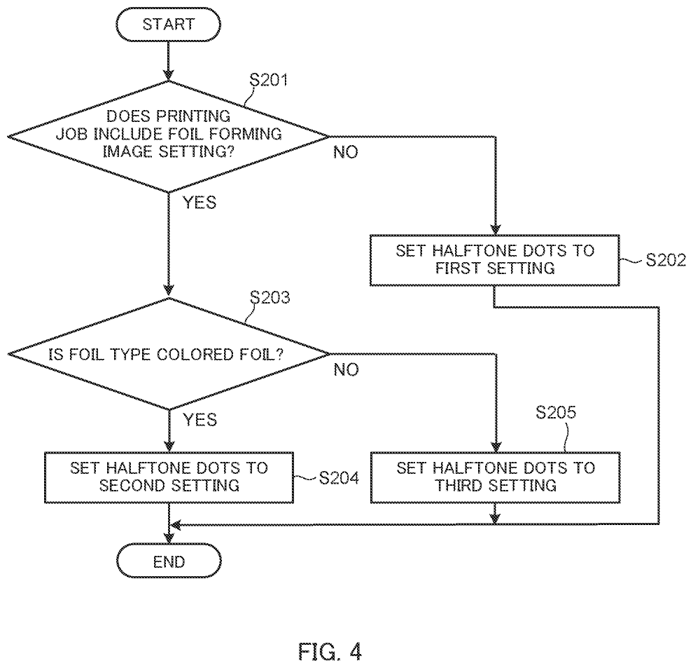

A description will be given of an exemplary operation of image data setting control based on the foil type. FIG. 4 is a flowchart illustrating the exemplary operation of the image data setting control based on the foil type in the image data setting apparatus in image data setting apparatus 100. Processing in FIG. 4 is appropriately performed when, for example, image data setting apparatus 100 receives an execution command of the printing job.

Note that, by way of example, in the flowchart in FIG. 4, when the foil type is colored foil, the halftone dots are set to the above-mentioned second setting, and when the foil type is a foil type other than that of the colored foil, the halftone dots are set to the third setting, which has the smaller line number of the halftone dots than that for the second setting.

As illustrated in FIG. 4, image data setting apparatus 100 determines whether the printing job includes the setting for the foil forming image setting (step S201). When the determination result indicates that the printing job includes no setting for the foil forming image (step S201, NO), image data setting apparatus 100 sets the halftone dots to the first setting (step S202).

In contrast, when the printing job includes the setting for the foil forming image (step S201, YES), image data setting apparatus 100 determines whether the foil type is the colored foil (step S203).

When the determination result indicates that the foil type is the color foil (step S203, YES), image data setting apparatus 100 sets the halftone dots to the second setting (step S204). On the other hand, when the foil type is not the colored foil (step S203, NO), image data setting apparatus 100 sets the halftone dots to the third setting (step S205). After step S202, step S204 or step S205, the control ends.

In the above embodiment, a setting for a recording medium, on which the foil forming image is formed, is not mentioned, but setting section 130 may control the line number of halftone dots in the halftone dot setting in accordance with the setting for the recording medium on which the foil forming image is formed.

The setting for the recording medium includes, for example, the type, the thickness, the processed state, and the sheet passing direction of recording medium. For example, in a case where the recording medium (type or processed state) has a good pressure-attachment property of the foil such as a matte sheet (or paper, hereinafter, referred to as “matte sheet”), the foil is likely to be attached by pressure to the toner image. Moreover, a setting for the transfer speed of recording medium and the transfer pressure in foil transfer section 21 differs depending on the thickness of recording medium and the sheet passing direction of recording medium; thus, the pressure-attachment property of the foil also differs.

Hence, setting section 130 controls the line number of halftone dots in accordance with the pressure-attachment property of the foil in the setting for the recording medium. Specifically, setting section 130 controls the line number of halftone dots so that the smaller the pressure-attachment property of the foil in the setting for the recording medium is, the smaller the line number of halftone dots is.

Thus, it is possible to accurately set the halftone dot setting and thereby perform the accurate hot stamping processing.

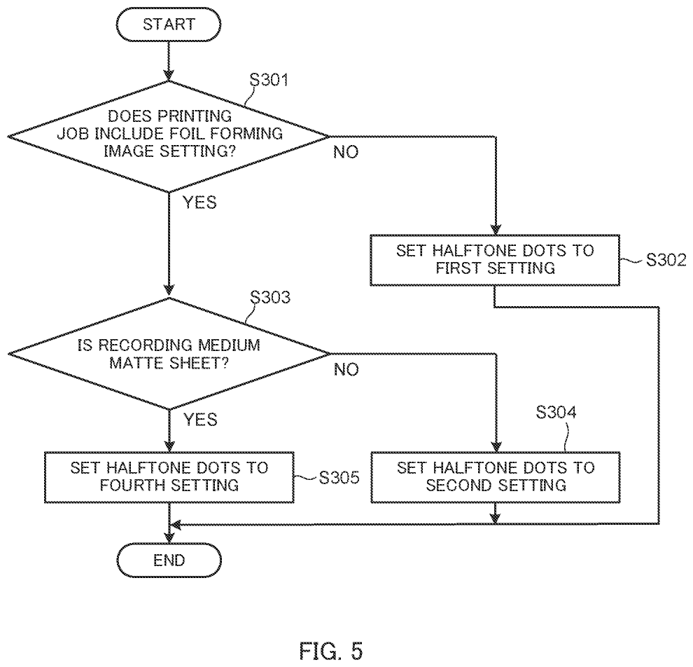

A description will be given of an exemplary operation of image data setting control based on the setting for the recording medium. FIG. 5 is a flowchart illustrating the exemplary operation of the image data setting control based on this recording medium setting in image data setting apparatus 100. Processing in FIG. 5 is appropriately performed when, for example, image data setting apparatus 100 receives an execution command. of the printing job.

Note that, by way of example, in the flowchart of FIG. 5, when the type of (setting for) recording medium is not the matte sheet, the halftone dots are set to the above-mentioned second setting, and whet. the type of (setting for) recording medium is the matte sheet, the halftone dots are set to the fourth setting, which has the larger line number of the halftone dots than the second setting.

As illustrated in FIG. 5, image data setting apparatus 100 determines whether the printing job includes the setting for the foil forming image setting (step S301). When the determination result indicates that the printing job includes no setting for the foil for image (step S301, NO), image data setting apparatus 100 sets the halftone dots to the first setting (step S302).

In contrast, when the printing job includes the setting for the foil forming image (step S301, YES), image data setting apparatus 100 determines whether the setting for the recording medium is the matte sheet (step S303).

When the determination result indicates that the setting for the recording medium is not the matte sheet (step S303, NO), image data setting apparatus 100 sets the halftone dots to the second setting (step S304). On the other hand, when the setting for the recording medium is the matte sheet (step S303, YES), image data setting apparatus 100 sets the halftone dots to the fourth setting (step S305). After step S302, step S304 or step S305, the control ends.

In the above-described embodiment, the type of toners is not mentioned, but setting section 130 may control the line number of halftone dots in the halftone dot setting based on the toner type.

Since the material of toners differs depending on the toner type, the viscosity of toners also differs. Hence, setting section 130 controls the line number of halftone dots in accordance with the viscosity of the toner. Specifically, setting section 130 controls the line number of halftone dots so that the smaller the viscosity of the toner is, the smaller the line number of halftone dots is.

Thus, it is possible to accurately set the halftone dot setting and thereby perform the accurate hot stamping processing.

The toner type may be identified in any manner, such as the color of a toner, the model of an image forming apparatus, the manufacturer of an image forming apparatus.

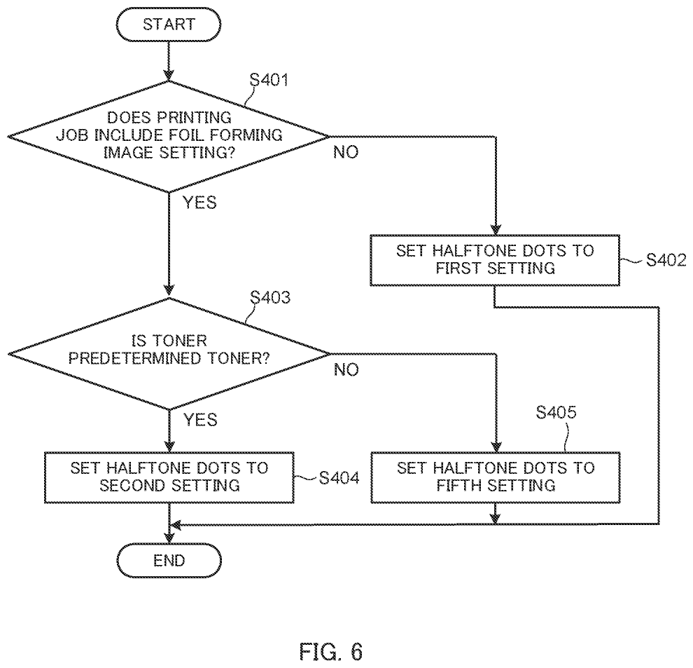

A description will be given of an exemplary operation of image data setting control based on the toner type. FIG. 6 is a flowchart illustrating the exemplary operation of the image data setting control based on the toner type in image data setting apparatus 100. Processing in FIG. 6 is appropriately performed when, for example, image data setting apparatus 100 receives an execution command of the printing job.

Note that, by way of example, in the flowchart of FIG. 6, when tile toner type is a predetermined toner, the halftone dots arc set to the above-mentioned second setting, and when the toner type is different from the predetermined. toner, the halftone dots are set to the fifth setting, which has the smaller line number of the halftone dots than the second setting. The predetermined toner is a toner having a relatively high viscosity, and the toner other than the predetermined toner is a toner having a lower viscosity than the predetermined toner.

As illustrated in FIG. 6, image data setting apparatus 100 determines whether the printing job includes the setting for the foil forming image setting (step S401). When the determination result indicates that the printing job includes no setting for the foil forming image (step S401, NO), image data setting apparatus 100 sets the halftone dots to the first setting (step S402).

In contrast, when the printing job includes the setting for the foil forming image (step S401, YES), image data setting apparatus 100 determines whether the toner type is the predetermined toner (step S403).

When the determination result indicates that the toner type is the predetermined toner (step S403, YES), image data setting apparatus 100 sets the halftone dots to the second setting (step S404). On the other hand, when the toner type is not the predetermined toner (step S403, NO), image data setting apparatus 100 sets the halftone dots to the fifth setting (step S105). After step S402, step S404 or step S405, the control ends.

In the above-described embodiment, the density of images is not mentioned, but setting section 130 may control the line number of halftone dots in the halftone dot setting based on the image density.

The lower the image density is, the fewer the number of halftone dots in the image is; thus, spaces between the halftone dots increases, which allows foils to be placed on the halftone dots, respectively. Hence, setting section 130 increases the line number of halftone dots as the image density becomes lower.

Thus, it is possible to accurately set the halftone dot setting and thereby perform the accurate hot stamping processing.

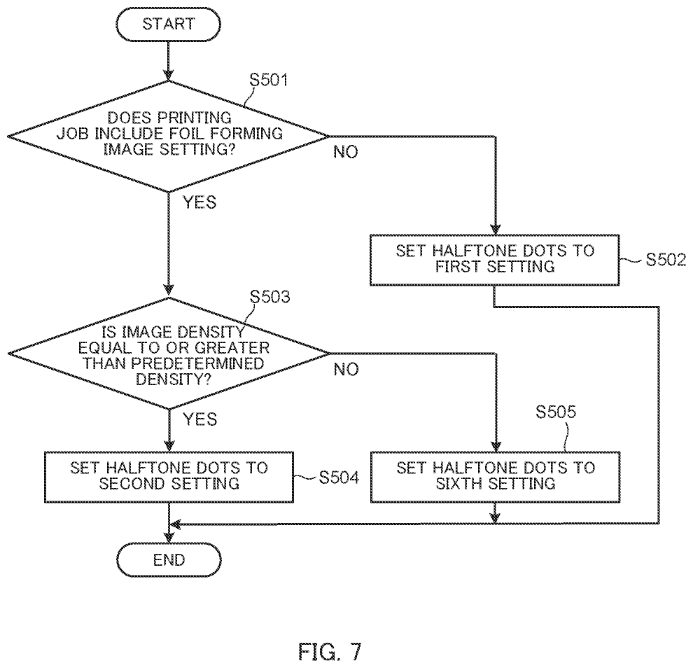

A description will be given of an exemplary operation of image data setting control based on the image density. FIG. 7 is a flowchart illustrating the exemplary operation of the image data setting control based on the image density in image data setting apparatus 100. Processing in FIG. 7 is appropriately performed when, for example, image data setting apparatus 100 receives an execution command of the printing job.

Note that, by way of example, in the flowchart of FIG. 7, when the image density is equal to or greater than a predetermined density, the halftone dots are set to the above-mentioned second setting, and when the image density is less than a predetermined density, the halftone dots are set to the sixth setting, which has the larger line number of the halftone dots than the second setting.

As illustrated in FIG. 7, image data setting apparatus 100 determines whether the printing job includes the setting for the foil forming image setting (step S501). When the determination result indicates that the printing job includes no setting for the foil forming image (step S501, NO), image data setting apparatus 100 sets the halftone dots to the first setting (step S502).

In contrast, when the printing job includes the setting for the foil forming image (step S501, YES), image data setting apparatus 100 determines whether the image density is equal to or greater than the predetermined density (step S503).

When the determination result indicates that the image density is equal to or greater than the predetermined density (step S503, YES), image data setting apparatus 100 sets the halftone dots to the second setting (step S504). On the other hand, when the image density is less than the predetermined density (step S503, NO), image data setting apparatus 100 sets the halftone dots to the sixth setting (step S505). After step S502, step S504 or step S505, the control ends.

Further, in the above embodiment, the line number of halftone dots is changed in a case where the printing job includes the selling for the foil forming image, the present invention is not limited to this. For example, the type of halftone dot settings may be changed.

Specifically, in a case where determination section 120 determines that the setting for the foil forming image is not included in the printing job, setting section 130 sets the halftone dot setting to a line type, and in a case where determination section 120 determines that the setting for the foil forming image is included in the printing job, setting section 130 sets the halftone dot setting to a dot type.

In other words, when forming the foil forming image, the halftone dot setting is set to the dot type so that the spaces between the halftone dots are increased, which allows foils to be placed on the halftone dots, respectively. Thus, it is possible to accurately set the halftone dot setting and thereby perform the accurate hot stamping processing.

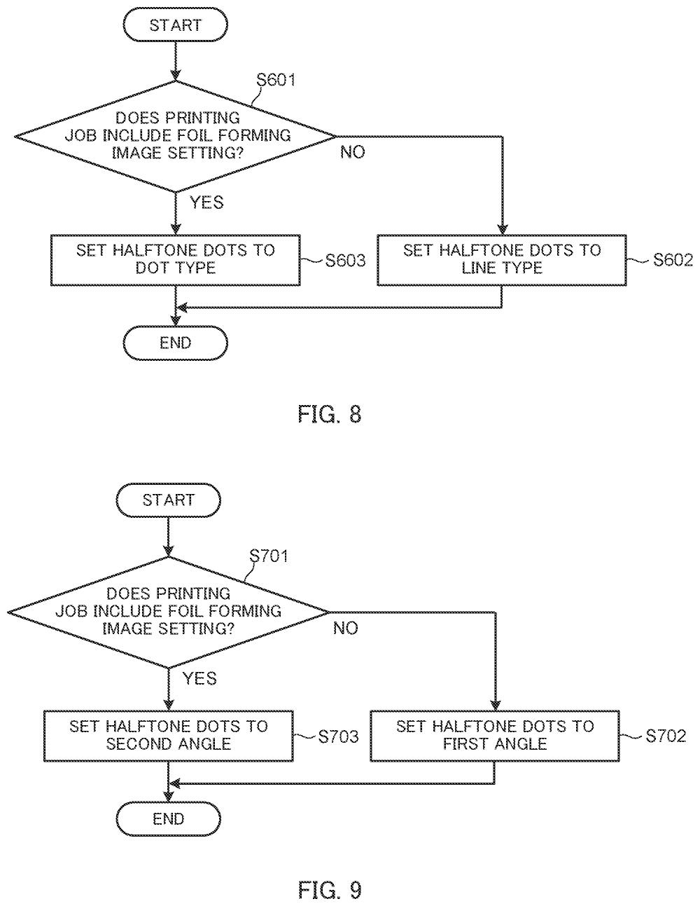

A description will be given of an exemplary operation of image data setting control in this image data setting apparatus 100. FIG. 8 is a flowchart illustrating the exemplary operation of the image data setting control in image data setting apparatus 100. Processing in FIG. 8 is appropriately performed when, for example, image data selling apparatus 100 receives an execution command of the printing job.

As illustrated in FIG. 8, image data setting apparatus 100 determines whether the printing job includes the setting for the foil forming image setting (step S601). When the determination result indicates that the printing job includes no setting for the foil forming image (step S601, NO), image data setting apparatus 100 sets the halftone dots to the line type (step S602).

In contrast, when the printing job includes the setting for the foil forming image (step S601, YES), image data setting apparatus 100 sets the halftone dots to the dot type (step S603). After step S602, or step S603, the control ends.

Besides, setting section 130 may change the angle of halftone dots in the halftone dot setting. Specifically, in a case where determination section 120 determines that the setting for the foil forming image is not included in the printing job, setting section 130 sets the angle in the halftone dot setting to the first angle, and in a case where determination section 120 determines that the setting for the foil forming image is included in the printing job, setting section 130 sets the angle in the halftone dot setting to the second angle.

The first angle is an angle, which is generally set for forming a normal image without forming a foil, and is appropriately set according to the color of toners. The second angle is an angle different from the first angle, in which spaces between the halftone dots is wider than those set in the first angle.

Thus, it is possible to accurately set the halftone dot setting and thereby perform the accurate hot stamping processing.

A description will be given of an exemplary operation of image data setting control in this image data setting apparatus 100. FIG. 9 is a flowchart illustrating the exemplary operation of the image data setting control in image data setting apparatus 100. Processing in FIG. 9 is appropriately performed when, for example, image data setting apparatus 100 receives an execution command of the printing job.

As illustrated in FIG. 9, image data setting apparatus 100 determines whether the printing job includes the setting for the foil forming image setting (step S701). When the determination result indicates that the printing job includes no setting for the foil forming image (step S701, NO), image data setting apparatus 100 sets the halftone dots to the first angel (step S702).

In contrast, when the printing job includes the setting for the foil forming image (step S701, YES), image data setting apparatus 100 sets the halftone dots to the second angle (step S703). After step S702, or step S703, the control ends.

Besides, the image formed in image forming apparatus 10 includes an inclined image which is inclined with respect to the conveyance direction. In a case of forming a foil on such an inclined image, it is necessary to adjust the second angle described above in accordance with the inclination of the inclined image.

That is, setting section 130 adjusts the second angle based on angular components of the image data. Regarding an adjusting method of the second angle, the following method may be used: an adjustment is made to the second angle which is set for an image with no inclination (set second angle), in order to set an adjusted second angle such that no misalignment occurs with respect to the toner image, considering an inclination angle of the inclined image and/or the setting for the recording medium (e.g., sheet passing direction).

In the manner described above, it is possible to set the halftone dots in accordance with the inclined image.

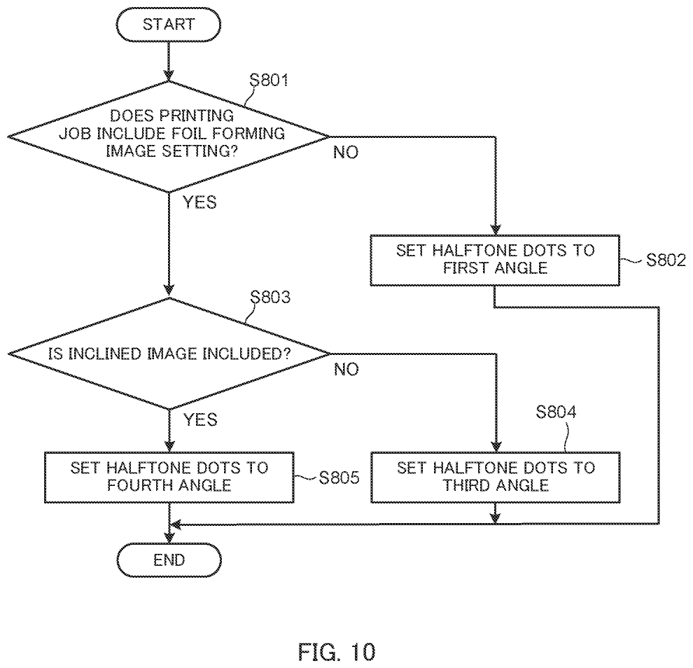

A description will be given of an exemplary operation of image data setting control in image data setting apparatus 100 that adjusts the second angle. FIG. 10 is a flowchart illustrating the exemplary operation of the image data selling control in image data selling apparatus 100 that adjusts the second angle. Processing in FIG. 10 is appropriately performed when, for example, image data setting apparatus 100 receives an execution command of the printing job.

Note that, by way of example, in the flowchart in FIG. 10, the set second angle when no inclined image is included in the image data is referred to as the third angle, and the adjusted second angle when the inclined image is included in the image data is referred to as the fourth angle.

As illustrated in FIG. 10, image data setting apparatus 100 determines whether the printing job includes the setting for the foil forming image setting (step S801). When the determination result indicates that the printing job includes no setting for the foil forming image (step S801, NO), image data setting apparatus 100 sets the halftone dots to the first angel (step S802).

In contrast, when the printing job includes the setting for the foil forming image (step S801, YES), image data setting apparatus 100 determines whether the image data includes the inclined image (step S803).

When the determination result indicates that the image data includes no inclined image (step S803, NO), image data setting apparatus 100 sets the halftone dots to the third angle (step S804). On the other hand, when the image data includes the inclined image (step S803, YES), image data setting apparatus 100 sets the halftone dots to the fourth angle (step S805). After step S802, step S804 or step S805, the control ends.

Besides, the halftone dot setting may be performed with reference to a table which associates the parameters according to the above embodiments with each other. That is, setting section 130 may control the halftone dot setting based on a combination of two or more of: the type of foils used for the foil forming image; the setting for the recording medium on which the foil forming image is formed; the type of toners used for the foil forming image; and the tone of the image data.

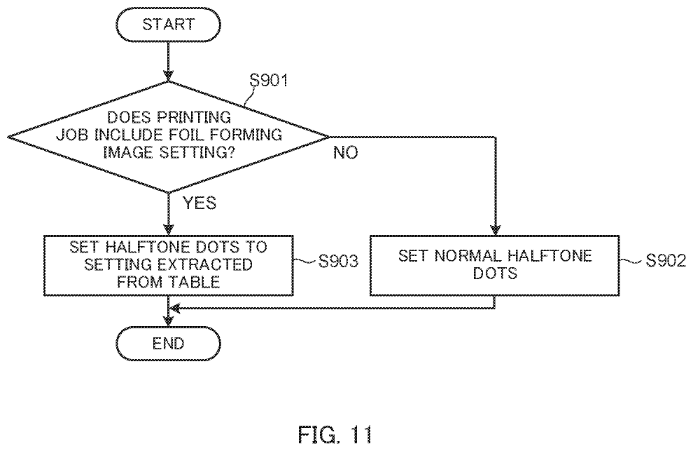

A description will be given of an exemplary operation of image data setting control in this image data setting apparatus 100. FIG. 11 is a flowchart illustrating the exemplary operation of the image data setting control in image data setting apparatus 100. Processing in FIG. 11 is appropriately performed when, for example, image data setting apparatus 100 receives an execution command of the printing job.

As illustrated in FIG. 11, image data setting apparatus 100 determines whether the printing job includes the setting for the foil forming image setting (step S901). When the determination result indicates that the printing job includes no setting for the foil for image (step S901, NO), image data setting apparatus 100 sets the halftone dots related to the normal setting (step S902).

In contrast, when the printing job includes the setting for the foil forming image (step S901, YES), image data setting apparatus 100 sets the halftone dots to the setting extracted from the above table (step S903). After step S902, or step S903, the control ends.

Besides, in the above embodiment, image data setting apparatus 100 is provided separately from image forming apparatus 10; however, the present invention is not limited to this. Image data setting apparatus 100 may be provided within the image forming apparatus.

Further, in the above embodiment, image forming apparatus 10 and hot stamping apparatus 20 are provided separately from each other; however, the present invention is not limited to this. The image forming apparatus and the hot stamping apparatus may be configured integrally.

The embodiments described above are merely examples of specific implementation of the present invention, and the technical scope of the present invention should not be restrictively interpreted by these embodiments. That is, the present invention may be implemented in various forms without departing from the spirit thereof or the major features thereof.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image data setting apparatus capable of setting image data related to a foil forming image, the image data setting apparatus comprising:
a hardware processor determining whether a setting for the foil forming image is included in a printing job related to the image data, wherein
the hardware processor changes a halftone dot setting of the image data, according to a determination result.

2. The image data setting apparatus according to claim 1, wherein
when determining that the setting for the foil forming image is included in the printing job, the hardware processor controls the halftone dot setting so that no foil is connected to an adjacent foil when foils are arranged on halftone dots, respectively.

3. The image data setting apparatus according to claim 1, wherein
when determining that the setting for the foil forming image is not included in the printing job, the hardware processor sets the halftone dot setting to a first setting, and
when determining that the setting for the foil forming image is included in the printing job, the hardware processor sets the halftone dot setting to a second setting in which a number of lines of halftone dots is smaller than that in the first setting.

4. The image data setting apparatus according to claim 1, wherein
the hardware processor controls a number of lines of halftone dots in the halftone dot setting based on a type of foil used for the foil forming image.

5. The image data setting apparatus according to claim 1, wherein
the hardware processor controls a number of lines of halftone dots in the halftone dot setting based on a setting for a recording medium on which the foil forming image is formed.

6. The image data setting apparatus according to claim 1, wherein
the hardware processor controls a number of lines of halftone dots in the halftone dot setting based on a type of toner used for the foil forming image.

7. The image data setting apparatus according to claim 1, wherein
the hardware processor controls a number of lines of halftone dots in the halftone dot setting based on a tone of the image data.

8. The image data setting apparatus according to claim 1, wherein
when determining that the setting for the foil forming image is not included in the printing job, the hardware processor sets the halftone dot setting to a line type, and
when determining that the setting for the foil forming image is included in the printing job, the hardware processor sets the halftone dot setting to a dot type.

9. The image data setting apparatus according to claim 1, wherein
when determining that the setting for the foil forming image is not included in the printing job, the hardware processor sets an angle in the halftone dot setting to a first angle, and
when determining that the setting for the foil forming image is included in the printing job, the hardware processor sets an angle in the halftone dot setting to a second angle different from the first angle.

10. The image data setting apparatus according to claim 9, wherein
the hardware processor adjusts the second angle based on an angular component of the image data when determining that the setting for the foil forming image is included in the printing job.

11. The image data setting apparatus according to claim 1, wherein
the hardware processor controls the halftone dot setting based on a combination of two or more of: a type of foil used for the foil forming image; a setting for a recording medium on which the foil forming image is formed; a type of toner used for the foil forming image; and a tone of the image data.

12. An image data setting method for an image data setting apparatus capable of setting image data related to a foil forming image, the image data setting method comprising:
determining whether a setting for the foil forming image is included in a printing job related to the image data; and
changing a halftone dot setting of the image data, according to a determination result.

13. A non-transitory computer-readable recording medium storing therein an image data setting program for an image data setting apparatus capable of setting image data related to a foil forming image, the program causing a computer to perform:
determining whether a setting for the foil forming image is included in a printing job related to the image data; and
changing a halftone dot setting of the image data, according to a determination result in the determining.
